(19) United States
(12) Patent Application Publication
(10) Pub. No.: US 2026/0287752 A1
(43) Pub. Date: Sep. 24, 2026

(54) DETECTING GNSS SPOOFING SIGNALS

(71) Applicant: Infinidome Ltd., Caesarea (IL)

(72) Inventors: Moshe KAPLAN, Pardes Hana-Karkur (IL); Pavel LIFSHITS, Haifa (IL)

(73) Assignee: Infinidome Ltd., Caesarea (IL)

(21) Appl. No.: 19/572,975

(22) Filed: Mar. 20, 2026

(30) Foreign Application Priority Data
Mar. 20, 2025 (IL) 319773

(51) Int. Cl. G01S 19/21; G01S 19/30

(52) U.S. Cl. CPC G01S 19/215; G01S 19/30

(57) ABSTRACT

A method and system for detecting global navigation satellite system (GNSS) spoofing signals using multiple antennas operating in a shared frequency band. For each of a plurality of pseudo-random codes pertaining to a plurality of satellites, a code phase difference value is calculated between phase-adjusted correlations of the pseudo-random code with intermediate frequency signals converted from radio frequency signals received by a first antenna and a second antenna. Clusters of code phase difference values are determined, wherein differences between values in a same cluster are below a predetermined threshold. A spoofing signal is identified responsive to determining that the clusters comprise at least a predetermined number of code phase difference values or exceed a predetermined number of clusters. Optionally, machine learning models are applied to extracted signal features to classify and count spoofing sources. A consensus method using three or more antennas computes a spoofing probability.

### RELATED APPLICATION(S)

This application claims the benefit of priority of Israel Patent Application No. 319773 filed on Mar. 20, 2025, the contents of which are incorporated by reference as if fully set forth herein in their entirety.

### FIELD AND BACKGROUND OF THE INVENTION

The present invention relates to the field of satellite navigation systems, and more particularly to methods and systems for detecting and quantifying spoofing signals in global navigation satellite systems (GNSS) using multiple antennas and signal processing techniques.

GNSS constellations, such as GPS, GLONASS, Galileo, and BeiDou, are widely used for navigation, positioning, and timing applications across various industries, including aviation, maritime, automotive, and telecommunications. The accuracy and reliability of GNSS are critical for the safety and efficiency of these applications.

However, GNSS signals are susceptible to intentional interference, such as jamming and spoofing. Spoofing involves the transmission of counterfeit GNSS signals to deceive receivers into calculating incorrect positions or timing information. This poses significant security risks, including potential hazards in navigation systems and vulnerabilities in critical infrastructure.

### SUMMARY OF THE INVENTION

The present invention addresses the need for a reliable GNSS spoofing detection by utilizing multiple antennas and advanced signal processing techniques to analyze code phase differences and, optionally, signal energy levels. By applying clustering algorithms and machine learning models, the system can identify anomalies indicative of spoofing attempts executed by ground stations or space vehicles, enhancing the robustness of GNSS receivers against interference.

According to an aspect of some embodiments of the present invention there is provided a processor-implemented method for determining the presence of a global navigation satellite spoofing signal, comprising operating a first antenna and a second antenna in a shared frequency band, for each of a plurality of pseudo-random codes pertaining to a plurality of satellites, calculating a code phase difference value between (i) a phase-adjusted correlation of the pseudo-random code with an intermediate frequency signal converted from a radio frequency signal received by the first antenna and (ii) a phase-adjusted correlation of the pseudo-random code with an intermediate frequency signal converted from a radio frequency signal received by the second antenna, determining clusters of code phase difference values, wherein a difference between at least two values in the same cluster is below a predetermined threshold, and responsive to at least one of determining that the clusters of code phase values comprise a total of at least a predetermined number of code phase difference values and determining that the total number of clusters of code phase values exceeds a predetermined number of clusters of code phase values, concluding that a global navigation satellite spoofing signal is present in the shared frequency band.

Optionally, the method further comprises for each of a plurality of pseudo-random codes pertaining to a plurality of satellites, estimating a signal energy level, determining clusters of signal energy level values, wherein a difference between at least two signal energy levels in a same cluster is below a predetermined threshold, and responsive to determining that the clusters of signal energy level values comprise a total of at least a predetermined number of signal energy levels, concluding that a global navigation satellite spoofing signal is present in the shared frequency band.

Optionally, determining clusters of code phase difference values comprises applying a k-means clustering algorithm to partition the code phase difference values into clusters, wherein the predetermined threshold corresponds to the maximum allowable intra-cluster distance.

According to an aspect of some embodiments of the present invention there is provided a processor-implemented method for determining the count of global navigation satellite spoofing signals, comprising operating a plurality of antennas in a shared frequency band, for each of the plurality of antennas, calculating a respective feature set based at least in part on a radio frequency signal received by the antenna, and aggregating the respective feature sets to produce an initial feature set, applying a first machine learning model to the initial feature set to produce a feature vector representing extracted signal characteristics, and applying a second machine learning model to the feature vector, the second machine learning model being trained to classify and count navigation satellite spoofing signals, thereby determining a count of navigation satellite spoofing signals present in the shared frequency band.

Optionally, the first machine learning model comprises a convolutional neural network (CNN), trained to extract spatial and sequential dependencies from the feature vector.

Optionally, the first machine learning model comprises a recurrent neural network (RNN), trained to extract sequential dependencies from the feature vector.

Optionally, the second machine learning model comprises a random forest classifier trained to classify the feature vector and determine the presence of navigation satellite spoofing signals.

Optionally, the second machine learning model comprises a gradient-boosted decision tree (GBDT) model trained to classify the feature vector and determine the presence of navigation satellite spoofing signals.

According to an aspect of some embodiments of the present invention there is provided a processor-implemented method for determining the presence of a global navigation satellite spoofing signal, comprising operating a plurality of two or more antennas in a shared frequency band, computing a 2-subset collection of the plurality of three or more antennas, wherein each 2-element subset comprises a first antenna and a second antenna, for each 2-element subset and each of a plurality of pseudo-random codes pertaining to a plurality of satellites, calculating a code phase difference value between a phase-adjusted correlation of the pseudo-random code with an intermediate frequency signal converted from a radio frequency signal received by a first antenna in a 2-element subset and a phase-adjusted correlation of the pseudo-random code with an intermediate frequency signal converted from a radio frequency signal received by a second antenna in the 2-element subset, for each 2-element subset, determining clusters of code phase difference values, wherein a difference between at least two code phase differences in a same cluster is below a predetermined threshold, determining a first count, comprising a count of 2-element subsets for which the clusters of code phase values comprise a total of at least a predetermined number of code phase difference values, determining a second count, comprising a total count of 2-element subsets, and computing a probability value of a global navigation satellite spoofing signal present in the shared frequency band based at least in part on the first count and the second count.

According to an aspect of some embodiments of the present invention there is provided a computer system comprising, a first radio frequency antenna, a second radio frequency antenna, a processor configured to execute stored executable instructions and a non-transitory computer readable medium storing executable instructions that, when executed by a processor, cause the computer system to operate a first antenna and a second antenna in a shared frequency band, for each of a plurality of pseudo-random codes pertaining to a plurality of satellites, calculate a code phase difference value between a phase-adjusted correlation of the pseudo-random code with an intermediate frequency signal converted from a radio frequency signal received by the first antenna and a phase-adjusted correlation of the pseudo-random code with an intermediate frequency signal converted from a radio frequency signal received by the second antenna, determine clusters of code phase difference, wherein a difference between at least two code phase differences in a same cluster is below a predetermined threshold and responsive to determining that the clusters of code phase values comprise a total of at least a predetermined number of code phase difference values, conclude that a global navigation satellite spoofing signal is present in the shared frequency band.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of GNSS positioning, according to the background of the invention;

FIG. 2 is a schematic illustration of a land-based GNSS spoofing attack, according to the background of the invention;

FIG. 3 is a schematic illustration of a space-based GNSS spoofing attack, according to the background of the invention;

FIG. 4 is a block diagram of a dual-antenna system for detecting GNSS spoofing signals, according to some embodiments of the invention;

FIG. 5 is a flowchart illustrating an analytical method for detecting GNSS spoofing signals, according to some embodiments of the invention;

FIG. 6 is a block diagram of a consensus system for detecting GNSS spoofing signals, according to some embodiments of the invention;

FIG. 7 is a flowchart illustrating a machine learning method for detecting GNSS spoofing signals, according to some embodiments of the invention; and

FIG. 8 is a diagram representing an embodiment of a dual-antenna GNSS spoofing signal detection system.

### DESCRIPTION OF SPECIFIC EMBODIMENTS OF THE INVENTION

As used herein, the term GNSS means “global navigation satellite system”.

Traditional methods for detecting GNSS spoofing rely on signal strength monitoring, consistency checks, or the use of specialized hardware, which may not be sufficient or cost-effective for all applications. There is a need for improved methods and systems that can accurately detect the presence of spoofing signals and determine their count.

The present invention relates to the field of satellite navigation systems, and more particularly to methods and systems for detecting and quantifying spoofing signals in global navigation satellite systems (GNSS) using multiple antennas and signal processing techniques.

According to one of the methods disclosed in the present application, a system and method are provided for detecting spoofing signals in a shared frequency band using multiple antennas and advanced signal processing techniques. The system leverages phase-adjusted correlations of pseudo-random codes received by two antennas to calculate code phase difference values, enabling identification of anomalies indicative of spoofing attempts.

As used herein, the term “cluster” refers to a group of values that are similar to one another according to a predetermined criterion. For example, a cluster of code phase difference values may consist of values where the difference between any two values in the cluster does not exceed a predetermined threshold.

The method described hereinbelow enables reliable detection of global navigation satellite system (GNSS) spoofing signals by analyzing temporal patterns in the received signals. By clustering code phase difference values and identifying signature patterns in clusters, the method allows for identification of individual spoofing signal sources.

The method described hereinbelow is particularly useful for critical navigation and timing applications, such as in aviation, maritime transport, autonomous vehicles, and critical infrastructure, where spoofing attacks pose a significant security risk. The ability to detect spoofing signals with high accuracy ensures the integrity of GNSS-based positioning systems, which are increasingly relied upon for safety and efficiency.

The present invention offers several notable advantages and improvements over the art. First, its variations can be used with either a pair of antennas or a set of multiple antennas, adding the ability to perform a consensus computation and to estimate the probability of a spoofing signal presence. Second, its variations allow for identification of spoofing signals originating from land-based stations as well as spoofing signals originating from alternative GNSS constellations. Third, the invention enables a receiver to perform spoofing detection in substantial real time, as it relies on techniques that require data acquisition over a span of only a few milliseconds.

Another key advantage of the method lies in its ability to identify consistent patterns across subsets of code phase differences. Spoofing signals, originating from a single source, typically exhibit tightly clustered and consistent code phase differences across multiple signals and antenna pairs. By contrast, unintentional interference, such as multipath effects, introduces stochastic variations in code phase differences due to the diverse reflection paths and attenuation effects. These variations result in dispersed or irregular clustering, which the method inherently detects through its clustering and thresholding process.

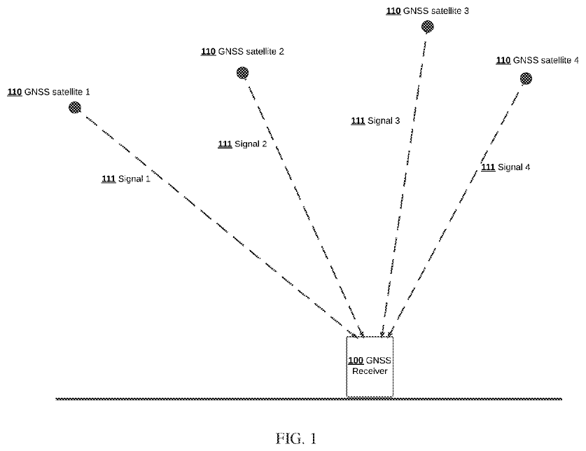

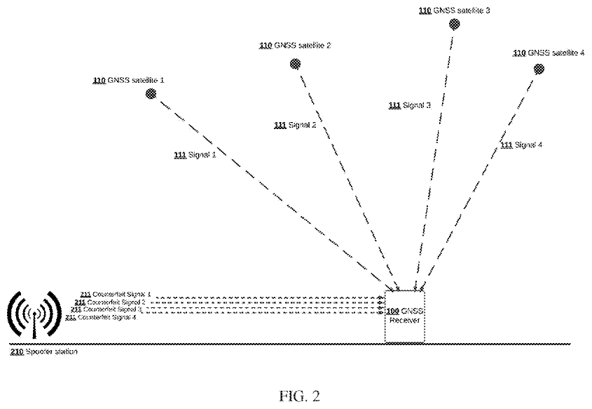

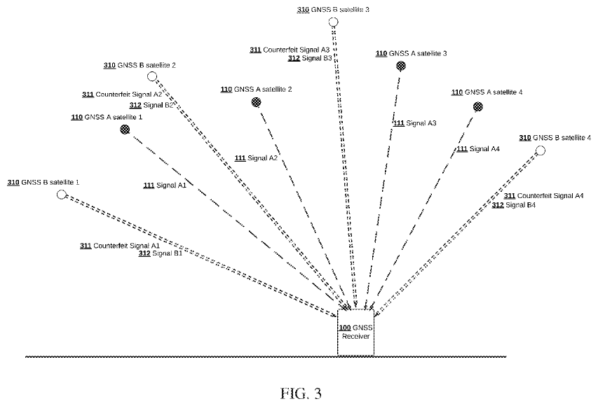

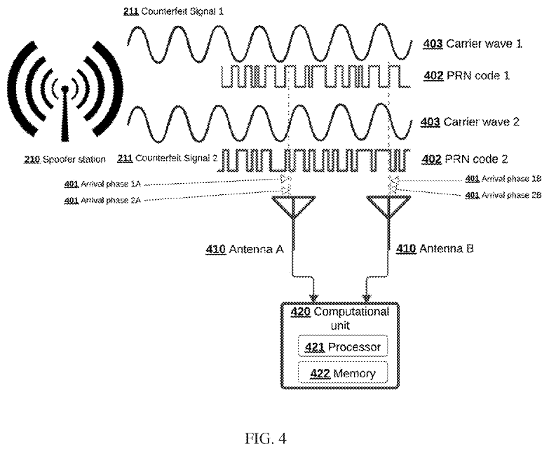

For purposes of better understanding some embodiments of the present invention, as illustrated in FIGS. 4-7 of the drawings, reference is first made to the operation of a GNSS system as illustrated in FIG. 1, and GNSS spoofing scenarios as illustrated in FIGS. 2-3.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As used herein, the term PRN means “pseudo-random noise”.

Referring now to the drawings, FIG. 1 schematically illustrates the basics of GNSS positioning. According to the background of the invention, a GNSS receiver 100 determines its position by receiving a plurality of radio signals 111 transmitted by a plurality of GNSS satellites 110 associated with a same constellation. Each satellite 110 transmits a signal 111 encoded with specific information that enables the receiver 100 to calculate its position and time with high precision. Signal 111 features comprise a carrier wave, a PRN code, ephemeris data, as well as other features that are not necessarily relevant to the disclosed invention.

A PRN code signal is a sequence of pseudo-random binary digits unique to a satellite 110. A PRN code serves two purposes: first, it enables a receiver 100 to identify an originating satellite 110 of a particular signal 111, and second, it enables the receiver 100 to determine the precise time at which the satellite 110 transmitted the signal 111. To achieve this, the receiver 100 generates an identical copy of the PRN code locally and matches it against the incoming signal 111. The receiver 100 determines the time shift required to align the locally generated code with the received code to calculate the signal travel time. This travel time is directly proportional to the distance between the satellite 110 and the receiver 100, referred to as the pseudorange. The receiver performs the procedure hereinabove for a plurality of PRN codes, each corresponding to a different satellite 110 in the constellation.

An ephemeris data signal (embedded in a navigation message) is critical for determining the precise position of a satellite 110 at the time a signal 111 was transmitted. The ephemeris data contains orbital parameters and clock correction information of the satellite 110, enabling the receiver 100 to calculate the satellite's 110 position and adjust for any satellite clock errors. The receiver 100 processes the ephemeris data and pseudorange measurements to calculate the satellite's 110 position in space. With the positions of at least four satellites 110 and their corresponding pseudoranges, the receiver 100 further solves for its three-dimensional position (latitude, longitude, and altitude) and corrects its own clock offset.

GNSS signals 111 are modulated onto a high-frequency carrier wave. The receiver 100 compares the phase of the carrier wave received with the phase of a locally generated carrier wave to refine the calculated distance to each satellite 110.

Reference is now made to FIG. 2, which illustrates a scenario of a land-based GNSS spoofing attack. According to the background of the invention, a GNSS receiver 100 intends to use signals 111 transmitted by a plurality of satellites 110 of a GNSS constellation to determine its position, and a malicious actor deploys a land-based spoofer 210, which generates and transmits a counterfeit signal 211 designed to mimic a legitimate signal 111 by replicating a PRN code associated with the legitimate signal 111 transmitted by a satellite 110.

The spoofer 210 synchronizes transmission of a PRN code in a counterfeit signal 211 with a timestamp, phase or manipulated ephemeris data altered to deceive a GNSS receiver 100, causing it to calculate an incorrect pseudorange and, consequently, derive an erroneous position. Such an attack may be successful when the amplitude of the counterfeit signals 211 enables them to dominate over legitimate signals 111, forcing the receiver 100 to exclusively process the spoofed data. The spoofer 210 may further generate a plurality of such counterfeit signals 211, corresponding to a plurality of legitimate signals 111, each associated with a satellite 110 within the estimated field of view of a receiver 100, denying to the receiver 100 reliable data acquisition from any legitimate signal 110 corresponding to the plurality of satellites 110.

Reference is now made to FIG. 3, which illustrates a scenario of a space-based GNSS spoofing attack. According to the background of the invention, a GNSS receiver 100 intends to use signals 111 transmitted by a plurality of satellites 110 of a first constellation GNSS-A to determine its position, and a malicious actor utilizes a plurality of satellites 310 of a second constellation GNSS-B which transmit counterfeit signals 311 designed to mimic the legitimate signals 111 of the first constellation GNSS-A in addition to their own legitimate signals 111.

A satellite 310 of the second constellation GNSS-B synchronizes transmission of a PRN code in a counterfeit signal 211 with a timestamp, phase or manipulated ephemeris data altered to deceive a GNSS receiver 100. Furthermore, a plurality of satellites 310 may generate a plurality of such counterfeit signals 311, each corresponding to a legitimate signal 111 associated with a distinct satellite 110 within the estimated field of view of a receiver 100, denying to the receiver 100 reliable data acquisition from any legitimate signal 110 corresponding to the plurality of satellites 110.

Reference is now made to FIG. 4, which is a block diagram of a dual-antenna system for detecting GNSS spoofing signals. According to some embodiments of the invention, a computational unit 420, comprising a processor 421 and a memory 422, is coupled to a pair of radio antennas 410 configured to operate in a shared frequency band utilized by a legitimate GNSS satellite constellation and, by extension, a land-based spoofer station 210.

For example, the spoofer station 210 transmits a plurality of counterfeit signals 211 as described hereinabove, modulating a PRN code 402 and a malicious navigational payload (not depicted) onto a high-frequency carrier wave 403 for each counterfeit signal 211. For example, the PRN code utilized by the Global Positioning System (GPS) comprises 1023 bits transmitted over 1 millisecond and continuously repeating, with payload navigational messages further modulated onto the PRN code.

As the speed of a carrier radio wave propagation is finite, and the first antenna and 410 the second antenna 410 are spatially separated, the counterfeit signal 211 reaches the first antenna 410 and the second antenna 410 at different time points for virtually all orientations of the pair of radio antennas 410 relative to the spoofer station 210. For example, at a fixed point in time the first antenna 110 measures a first counterfeit signal 211 at a code phase 401 1A and a second counterfeit signal 211 at a code phase 401 2A, while at the same fixed point in time the second antenna 110 measures the first counterfeit signal 211 at a code phase 401 1B and the second counterfeit signal 211 at a code phase 2B.

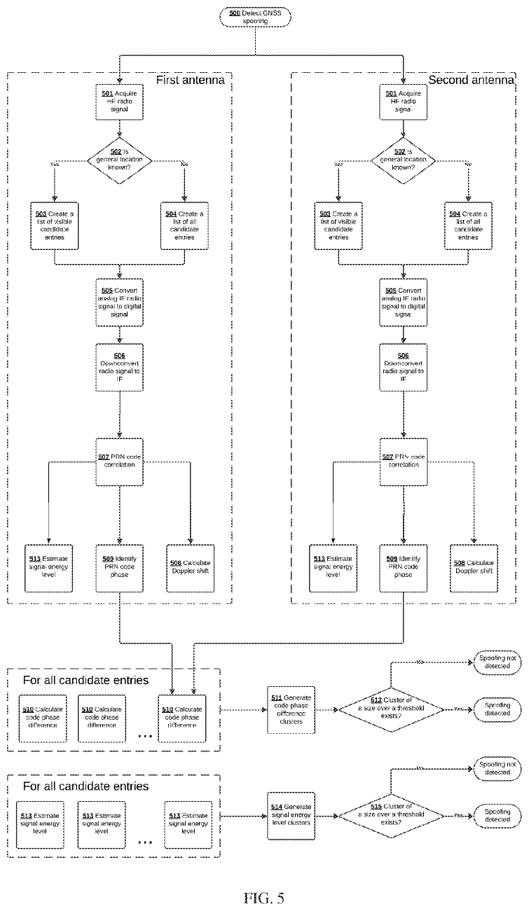

Reference is now made to FIG. 5, which is a flowchart illustrating an analytical method for detecting GNSS spoofing signals.

As used herein, the term “IF” means “intermediate frequency”.

According to some embodiments of the invention, the computational unit 420 acquires 501 a high-frequency radio sample of a duration corresponding to a PRN code cycle characteristic to a GNSS constellation. For example, when detecting presence of GPS spoofing the computational unit 420 acquires a 10 millisecond sample.

Optionally, at the decision step 502 a determination is made as to whether the computational unit 420 possesses information on a general location of the receiver 100 as acquired from an external source. Optionally, responsive to presence of information on general location of the receiver 100, the computational unit 420 determines the potential visibility of a plurality of satellites 110 comprising the GNSS constellation, and populates 503 a data structure such as a list, an associative array or a set with candidate entries corresponding to satellites 110 that are expected to be visible to the receiver 100 based on a general location of the receiver 100 acquired from an external source. Optionally, responsive to an absence of a general location of the receiver 100, the computational unit 420 populates 504 the data structure with candidate entries corresponding to all active satellites 110 comprising the GNSS constellation.

Optionally, the computational unit 420 performs 505 an analog-to-digital conversion of the IF signal, thereby generating a digital signal.

Optionally, the computational unit 420 downconverts 506 a signal measured at an antenna 410 to IF, thereby generating an IF signal. Optionally, the computational unit 420 is configured to perform direct downconversion. Optionally, the computational unit 420 is configured to perform indirect downconversion.

As used herein, the term “phase-adjusted correlation” refers to the process of comparing a PRN code to a digital signal, wherein the PRN code is phase-shifted over multiple iterations to identify the alignment that maximizes correlation.

Optionally, the computational unit 420 performs 507 correlation of the digital signal with a PRN code of a candidate entry for a number of iterations equal to at least half of the total number of chips in the PRN code over the acquired sample duration, thereby performing phase-adjusted correlation. Each iteration corresponds to a distinct code phase offset, ensuring that all possible alignments between the PRN code and the received signal are examined. Optionally, the computational unit 420 performs correlation of the digital signal with the PRN code of a candidate entry with a sub-chip resolution. Optionally, the computational unit 420 is configured to perform digital signal correlation to a plurality of PRN codes at a plurality of offsets in parallel.

In an embodiment, the computational unit 420 calculates 508 a Doppler offset associated with a candidate entry for the IF signal. This calculation compensates for the relative motion between a candidate entry and the receiver 100, enabling the computational unit 420 to adjust the locally generated signal frequency to match the received signal frequency. By correcting for Doppler shifts, the computational unit 420 ensures accurate acquisition and tracking of the satellite signal.

Optionally, the computational unit 420 subsequently identifies 509 the code phase of the digital signal by selecting the correlation offset that yields the highest correlation value, ensuring precise alignment with the PRN code of the candidate entry.

Optionally, the computational unit 420 is configured to perform at least one of a downconversion, Doppler shift calculation, analog-to-digital conversion and code phase determination for a plurality of signals measured at the first antenna 410 and the second antenna 410 in parallel.

Optionally, the computational unit 420 calculates 510 a code phase difference between a first code phase 401 associated with a PRN code and a signal measured at the first antenna 410 and the a second code phase 401 associated with the same PRN code and a signal measured at the second antenna 410. This calculation enables the computational unit 420 to derive the time delay of arrival of the signal carrying the PRN code between the two antennas 410, enabling an estimate of the direction to the source of the signal. Optionally, the computational unit 420 calculates 510 a code phase difference for each PRN code associated with a candidate entry or a subset thereof.

As used herein, the term “predetermined threshold” refers to a fixed or dynamically set value used to evaluate the similarity of signal characteristics. For example, a predetermined threshold for clustering may be set to 2 degrees for code phase differences.

Optionally, the computational unit 420 generates 511 a plurality of clusters of code phase difference values, wherein a difference between all values in a cluster is below a predetermined threshold. Multiple clusters may contain code phase difference values associated with identical PRN codes if those values meet the criteria for inclusion in each cluster.

In an embodiment, the computational unit 420 generates 511 a plurality of clusters of code phase difference values by applying a clustering algorithm.

Optionally, the clustering algorithm comprises the k-means algorithm. The k-means algorithm partitions the code phase difference values into clusters by minimizing the intra-cluster distances. A predetermined threshold defines the maximum allowable distance within a cluster, ensuring that only closely aligned values are grouped together. This approach is effective for identifying spoofing signals that exhibit tight consistency in code phase differences.

Optionally, the computational unit 420 generates 511 a plurality of clusters of code phase difference values using a Gaussian mixture model (GMM). The GMM estimates the underlying probability distribution of the code phase difference values, assigning each value to a cluster based on the likelihood that it belongs to a specific Gaussian component. This probabilistic approach allows for more nuanced clustering, accommodating overlapping clusters and variations in cluster shapes that may arise due to spoofing or interference.

Optionally, at step 512, the computational unit 420 determines whether any cluster of code phase difference values contains four or more entries. Responsive to determining that at least one such cluster exists, the computational unit 420 identifies each signal corresponding to a PRN code within any of such clusters as a counterfeit signal 211. Furthermore, the computational unit 420 classifies each such cluster as indicative of a potential land-based spoofer station 210 activity.

Optionally, the computational unit 420 executes steps 501-512 iteratively, aggregating the results of multiple iterations. For example, the computational unit 420 may perform five iterations of steps 501-512 and output a determination that an active land-based spoofer station 210 is present if at least three iterations identify spoofer station 210 activity. Conversely, if fewer than three iterations identify such activity, the computational unit 420 outputs a determination that no active land-based spoofer station 210 is present.

Optionally, the computational unit 420 outputs identifiers of satellites 110 associated with the PRN codes representing counterfeit signals 211.

Optionally, the computational unit 420 determines 513 signal energy level value of a signal corresponding to a PRN code as measured at an antenna 410. The computational unit 420 calculates this energy level after isolating the signal through correlation with the PRN code, ensuring that the measurement corresponds specifically to the signal associated with a single satellite or source. Optionally, the computational unit 420 further generates 514 a plurality of clusters of signal energy level values, wherein a difference between all values in a cluster is below a predetermined threshold. Multiple clusters may contain signal energy values associated with identical PRN codes if those values meet the criteria for inclusion in each cluster.

Optionally, at step 515, the computational unit 420 determines whether any cluster of signal energy level values contains four or more entries. Responsive to determining that at least one such cluster exists, the computational unit 420 identifies each signal corresponding to a PRN code within any of such clusters as a counterfeit signal 211. Furthermore, the computational unit 420 classifies each such cluster as indicative of a potential land-based spoofer station 210 activity.

Optionally, the computational unit 420 integrates the results of steps 509-512, which involve code phase analysis, and steps 513-515, which involve energy level analysis, into a unified decision-making process. The computational unit 420 evaluates both code phase clustering and signal energy clustering to identify counterfeit signals 211 and classify clusters as indicative of potential land-based spoofer station 210 activity. The computational unit 420 may assign different weights to the results of code phase analysis and energy level analysis based on predefined criteria, enhancing the robustness of spoofer detection.

Optionally, the computational unit 420 determines a total count of satellites 110 associated with PRN codes identified in signals measured by the first and second antennas 410, a count of counterfeit signals 211 mimicking satellites 110, and computes a probability of potential land-based spoofer station 210 activity based at least in part on these counts. For example, the computational unit 420 may output a probability of 100% of a spoofer station 210 activity if the count of counterfeit signals 211 equals to the count of all visible satellites 110.

Optionally, the computational unit 420 seeks and processes signals received from satellites 110 comprising a first GNSS constellation (GNSS-A) and satellites 310 comprising a second GNSS constellation (GNSS-B). Examples of such constellations include GPS, BeiDou, GLONASS, Galileo, and QZSS. For each received signal 111, 311, 312, the computational unit 420 identifies a corresponding constellation identifier and a PRN code, determines an associated code phase difference as described hereinabove, stores the constellation identifier, the PRN code, and code phase difference in a data structure such as a list or an associative array to facilitate a cross-constellation analysis, and performs clustering based on code phase differences as disclosed hereinabove.

Optionally, at step 512, the computational unit 420 determines whether any cluster of code phase difference values contains two or more entries associated with at least two distinct constellations GNSS-A and GNSS-B. Responsive to determining that at least one such cluster exists, the computational unit 420 identifies each signal corresponding to a PRN code within any of such clusters as a potentially counterfeit signal 311. Furthermore, the computational unit 420 classifies each such cluster as indicative of a potential space-borne spoofer 310 activity.

Optionally, the computational unit 420 outputs identifiers of satellites 310, 310 associated with the PRN codes representing potentially counterfeit signals 311, 111, or identifiers of the respective GNSS constellations.

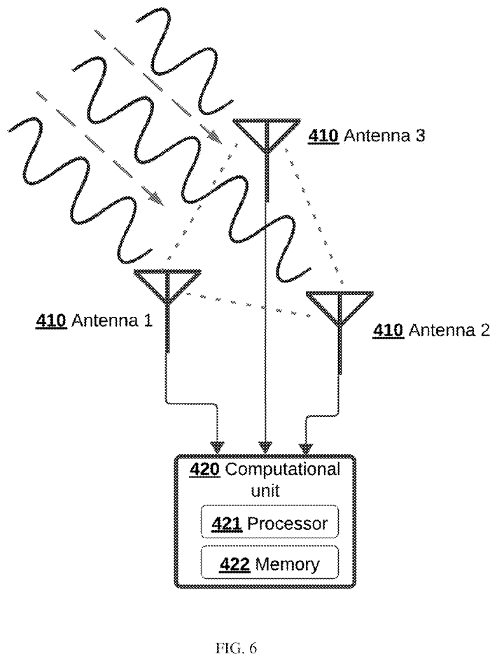

Reference is now made to FIG. 6, which is a block diagram of a consensus system for detecting GNSS spoofing signals. According to some embodiments of the invention, a computational unit 420, comprising a processor 421 and a memory 422, is coupled to three or more radio antennas 410 configured to operate in a shared frequency band utilized by a legitimate GNSS satellite constellation. The computational unit 420 executes a processor-implemented method to identify spoofing signals by analyzing code phase differences between signals received at different antenna pairs, as disclosed hereinbelow.

Optionally, the computational unit 420 simultaneously operates all antennas 410 in the shared GNSS frequency band (e.g., L1 at 1575.42 MHz). Each antenna 410 independently receives RF signals from GNSS satellites and potential spoofers.

Optionally, the computational unit 420 calculates a set of all possible 2-subset combinations of antennas 410, wherein each subset comprises a unique pair of antennas 410. This results in

$$( \begin{matrix}N \\ 2\end{matrix} ) = \frac{N ( N - 1 )}{2} 2 - subsets .$$

For the example illustrated in FIG. 6, the 2-subsets include {A₁, A₂}, {A₂, A₃}, {A₁, A₃}.

Optionally, the computational unit 420 discards one of the 2-subsets from the set, as the corresponding information can be derived from the remaining subsets, as code phase differences of all the antenna pairs are not entirely independent.

Optionally, for each 2-subset corresponding to a unique pair of antennas 410, the computational unit 420 performs the process comprising steps 501-512 as disclosed hereinabove, and records the detection result for each pair. The detection result may include a binary flag indicating the presence or absence of spoofing, as well as supporting data, such as a number of clusters and characteristics of detected spoofing signals. The computational unit 420 subsequently calculates a spoofing presence confidence based on a count of 2-subsets that indicate a presence of a spoofing signal within the shared frequency band, a total count of 2-subsets, radii of clusters of code phase difference values, signal-to-noise ratios of the received signals, or other parameters.

Optionally, the computational unit 420 compares the spoofing presence confidence against a predefined threshold to generate a binary decision (e.g., “spoofing detected” or “no spoofing detected”), and outputs the calculated spoofing presence confidence, along with additional diagnostic information, such as the list of 2-subsets contributing to the spoofing determination and relevant cluster details.

Optionally, the computational unit 420 determines a spoofing presence confidence for each individual GNSS satellite in a plurality of GNSS satellites, and outputs identifiers and spoofing presence confidence values for each GNSS satellite possessing a spoofing presence confidence value above a predetermined threshold.

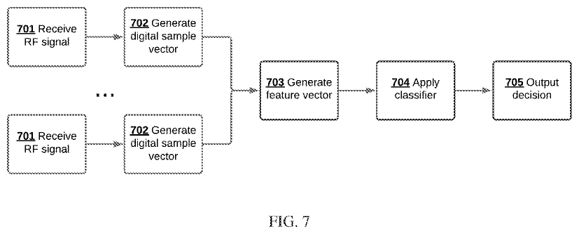

Reference is now made to FIG. 7, which illustrates a machine learning method for detecting GNSS spoofing signals. According to some embodiments of the invention, the method processes raw sampled signals received by a plurality of antennas 410, applies feature extraction, and classifies the resulting features to detect and quantify spoofing sources.

Optionally, the feature extraction algorithm is based on a neural network.

Optionally, the computational unit 420 operates a plurality of antennas 410 in a shared GNSS frequency band. Each antenna 410 independently receives 701 raw RF signals from GNSS satellites and potential spoofing sources such as a land-based spoofing station 210. The computational unit 420 performs, for each antenna, the process comprising steps 501-505 as disclosed hereinabove, generating 702 a vector of digital signal samples. For example, sampling two antennas at 16 MHz for 5 milliseconds yields two vectors of 80,000 samples each.

As used herein, the term “feature set” refers to a collection of parameters or characteristics derived from raw signals received by an antenna. Said features may include, but are not limited to, signal energy levels, Doppler shifts, code phase offsets, residual pseudorange values, and signal polarization properties. Said features may also lack direct interpretability.

Optionally, the computational unit 420 transforms 703 the feature set comprising a combination of all digital signal sample vectors from all antennas 410 into a compact representation by applying a neural network or another stochastic optimization process, thereby generating a feature vector. The feature vector encodes high-level characteristics of the received signals that are learned directly from the raw sampled data. For instance, the feature vector may have a fixed size (e.g., 1×100) irrespective of the size of the raw sampled input.

Optionally, the first machine learning model comprises a convolutional neural network (CNN). The CNN is designed to capture spatial patterns and local dependencies in the signal data by applying convolutional filters over the input. These filters extract features such as amplitude patterns, timing anomalies, or spectral irregularities indicative of spoofing or interference. The CNN may include pooling layers to reduce dimensionality while retaining key features and fully connected layers to output a fixed-size feature vector.

Optionally, the first machine learning model comprises a recurrent neural network (RNN). The RNN, including the long short-term memory (LSTM) network, is particularly well-suited for analyzing time-series data and identifying evolving patterns that may distinguish spoofing from legitimate signals.

Optionally, the first machine learning model is trained using labeled datasets that include examples of legitimate GNSS signals, spoofing signals, and multipath-affected signals. The training process optimizes the model to minimize classification or reconstruction errors using methods such as backpropagation and stochastic gradient descent. The model generalizes to new signals by learning to detect invariant patterns associated with spoofing or interference.

Optionally, the computational unit 420 applies 704 a second machine learning model to the feature vector to identify spoofing signals and determine the count of spoofing sources. The second machine learning model may implement clustering, supervised classification, or other machine learning techniques to detect anomalies in the feature vector indicative of spoofing activity.

Optionally, the second machine learning model comprises a random forest classifier, which operates by aggregating the outputs of multiple decision trees. Each decision tree evaluates different aspects of the feature vector, and the random forest combines these outputs to improve classification accuracy and robustness. This ensemble learning approach is effective for distinguishing spoofing signals from legitimate or multipath-affected signals.

Optionally, the second machine learning model comprises a gradient-boosted decision tree (GBDT) model. The GBDT incrementally trains decision trees to correct errors from previous iterations, enabling high accuracy in classification tasks. The model identifies subtle patterns in the feature vector that correlate with spoofing signals, providing precise detection and count outputs.

Optionally, the second machine learning model is trained on labeled datasets containing legitimate GNSS signals, spoofing signals, and multipath interference scenarios. The training process optimizes the model to minimize classification errors using iterative boosting or impurity minimization techniques. Validation methods, such as k-fold cross-validation, ensure that the model generalizes well to unseen data, maintaining high reliability in spoofing detection.

Optionally, the classifier outputs 705 a list of identifiers of satellites 110 associated with PRN codes suspected to be spoofed. Optionally, the classifier outputs a mapping of said identifiers to corresponding probability estimates, where each probability reflects the likelihood of the respective satellite 110 being spoofed. Optionally, the classifier applies a threshold to these probabilities to classify each satellite as “spoofed” or “not spoofed,” providing binary decisions alongside probability scores.

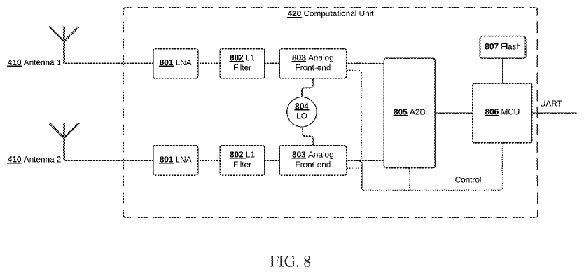

Reference is now made to FIG. 8, which is a diagram representing an embodiment of a dual-antenna GNSS signal processing apparatus designed for detecting spoofing signals and performing precise navigation computations. The system comprises two antennas 410 and a computational unit 420, in turn comprising a signal filtering and conditioning chain, an analog-to-digital conversion unit, a processing unit, and supporting components.

The first and the second antennas 410 are configured to receive GNSS signals in a shared frequency band such as L1. Each antenna 410 measures signals incoming from GNSS satellites and other potential signal sources such as spoofers, and forwards the received signals to a subsequent filtering stage.

The computational unit 420 first passes a signal received by an antenna 410 through a low-noise amplifier (LNA) 801 and an L1 bandpass filter 802. An LNA 801 is specifically designed to amplify weak GNSS signals received by an antenna 410 while minimizing the addition of noise to the signal. An L1 bandpass filter 802 is specifically designed to isolate the GNSS L1 frequency band. A bandpass filter suppresses out-of-band noise and interference, ensuring that only signals within the relevant frequency range proceed to the next stage.

The computational unit 420 then routes a signal filtered by a bandpass filter 802 to an analog front-end module 803. For example, an analog front-end module 803 may comprise a integrated circuit. An analog front-end module performs several key functions, including low-noise amplification (amplifying a weak GNSS signal without significantly increasing noise), mixing (downconverting a high-frequency RF signal to an IF signal using a local oscillator signal provided by a shared local oscillator (LO) module), and filtering (further suppressing noise components that may remain after the initial bandpass filtering).

The use of separate analog front-end modules for each antenna enables the system to maintain independent signal paths, which is critical for time-of-arrival and code phase calculations.

A shared LO module 804 provides a stable reference frequency for the downconversion process in the analog front-end modules 803. The LO module 804 enables precise mixing of an incoming high-frequency RF signal to an IF signal. The shared LO module 804 enables synchronization between the two signal paths, which is essential for time-delay-of-arrival and Doppler offset calculations.

The computational unit 420 then routes a first IF signal and a second IF signal to an Analog-to-Digital (A2D) Converter 805. The A2D converter 805 samples an analog signal at a high rate (e.g., 2× or 4× the Nyquist frequency for an IF signal) and converts it into a digital signal. The digital signal is subsequently processed to extract GNSS data such as a pseudorange, a code phase offset, a Doppler offset, and a signal energy level.

The computational unit 420 then routes the digitized signals to a microcontroller unit (MCU) 806. The MCU 806 is responsible for signal processing (performing correlation with PRN codes, Doppler compensation, clustering, and spoofing detection algorithms as disclosed hereinabove), data management (handling data structures such as candidate lists for PRN codes, correlation results, and clustering outputs), saving and loading data into a flash memory module 807 (such as reading firmware for the MCU 806, reading preloaded PRN codes for GNSS constellations and system configurations, and writing spoofing detection results or signal analysis data), and control operations.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the Applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A processor-implemented method for determining the presence of a global navigation satellite spoofing signal, comprising:
operating a first antenna and a second antenna in a shared frequency band;
for each of a plurality of pseudo-random codes pertaining to a plurality of satellites, calculating a code phase difference value between (i) a phase-adjusted correlation of the pseudo-random code with an intermediate frequency signal converted from a radio frequency signal received by the first antenna and (ii) a phase-adjusted correlation of the pseudo-random code with an intermediate frequency signal converted from a radio frequency signal received by the second antenna;
determining clusters of code phase difference values, wherein a difference between at least two values in the same cluster is below a predetermined threshold; and
responsive to at least one of:
determining that the clusters of code phase values comprise a total of at least a predetermined number of code phase difference values; and
determining that the total number of clusters of code phase values exceeds a predetermined number of clusters of code phase values,
concluding that a global navigation satellite spoofing signal is present in the shared frequency band.

2. The method according to claim 1, further comprising:
for each of a plurality of pseudo-random codes pertaining to a plurality of satellites, estimating a signal energy level;
determining clusters of signal energy level values, wherein a difference between at least two signal energy levels in a same cluster is below a predetermined threshold; and
responsive to determining that the clusters of signal energy level values comprise a total of at least a predetermined number of signal energy levels, concluding that a global navigation satellite spoofing signal is present in the shared frequency band.

3. The method according to claim 1, wherein determining clusters of code phase difference values comprises applying a k-means clustering algorithm to partition the code phase difference values into clusters, and wherein the predetermined threshold corresponds to the maximum allowable intra-cluster distance.

4. A processor-implemented method for determining the count of global navigation satellite spoofing signals, comprising:
operating a plurality of antennas in a shared frequency band;
for each of the plurality of antennas, calculating a respective feature set based at least in part on a radio frequency signal received by the antenna, and aggregating the respective feature sets to produce an initial feature set;
applying a first machine learning model to the initial feature set to produce a feature vector representing extracted signal characteristics; and
applying a second machine learning model to the feature vector, the second machine learning model being trained to classify and count navigation satellite spoofing signals, thereby determining a count of navigation satellite spoofing signals present in the shared frequency band.

5. The method according to claim 4, wherein the first machine learning model comprises a convolutional neural network (CNN), trained to extract spatial and sequential dependencies from the feature vector.

6. The method according to claim 4, wherein the first machine learning model comprises a recurrent neural network (RNN), trained to extract sequential dependencies from the feature vector.

7. The method according to claim 4, wherein the second machine learning model comprises a random forest classifier trained to classify the feature vector and determine the presence of navigation satellite spoofing signals.

8. The method according to claim 4, wherein the second machine learning model comprises a gradient-boosted decision tree (GBDT) model trained to classify the feature vector and determine the presence of navigation satellite spoofing signals.

9. A processor-implemented method for determining the presence of a global navigation satellite spoofing signal, comprising:
operating a plurality of two or more antennas in a shared frequency band;
computing a 2-subset collection of the plurality of three or more antennas, wherein each 2-element subset comprises a first antenna and a second antenna;
for each 2-element subset and each of a plurality of pseudo-random codes pertaining to a plurality of satellites, calculating a code phase difference value between a phase-adjusted correlation of the pseudo-random code with an intermediate frequency signal converted from a radio frequency signal received by a first antenna in a 2-element subset and a phase-adjusted correlation of the pseudo-random code with an intermediate frequency signal converted from a radio frequency signal received by a second antenna in the 2-element subset;
for each 2-element subset, determining clusters of code phase difference values, wherein a difference between at least two code phase differences in a same cluster is below a predetermined threshold;
determining a first count, comprising a count of 2-element subsets for which the clusters of code phase values comprise a total of at least a predetermined number of code phase difference values;
determining a second count, comprising a total count of 2-element subsets; and
computing a probability value of a global navigation satellite spoofing signal present in the shared frequency band based at least in part on the first count and the second count.
